(19) United States
(12) Patent Application Publication
(10) Pub. No.: US 2015/0233788 A1
(43) Pub. Date: Aug. 20, 2015

(54) SYSTEM AND METHOD FOR TESTING OF SEAL MATERIALS

(71) Applicant: Caterpillar Inc., Peoria, IL (US)

(72) Inventors: Jay H. Cline, Hopewell, IL (US); Khaled M. Mohammad, Tremont, IL (US); Sarfraz Alam, Peoria, IL (US); Eric L Woods, Creve Coeur, IL (US); James F. Monger, Beardstown, IL (US); Kevin D'Sa, Dunlap, IL (US)

(73) Assignee: Caterpillar Inc., Peoria, IL (US)

(21) Appl. No.: 14/704,966

(22) Filed: May 6, 2015

(51) Int. Cl. G01M 13/00; G01M 3/02

(52) U.S. Cl. CPC G01M 13/005; G01M 3/02

(57) ABSTRACT

A method for testing a performance of a plurality of sealing members includes providing a testing fixture including at least two blocks in a contacting relationship with a plurality of fixtures. Each of the plurality of fixtures defines a groove portion for receiving a sealing member. The method further includes connecting each of the plurality of fixtures with a fluid manifold. The method also includes controlling a temperature of each of the at least two blocks and the groove portion using a thermal device. Each of the at least two blocks and the groove portions are at temperatures different from each other. The method also includes passing a fluid through each of the plurality of fixtures so as to flow through a channel provided adjacent to and surrounding the groove portion. The method further includes monitoring a response of the sealing members to determine at least one performance parameter.

### TECHNICAL FIELD

The present disclosure relates to a system and method for testing of seal materials, and more particularly to the testing of the seal materials in which fluid temperatures and seal temperatures can be varied.

### BACKGROUND

Sealing members, such as, O-rings are commonly made of elastomeric materials. Elastomeric materials are generally conformable, free of porosity, and relatively resilient, thereby creating a relatively impermeable seal when positioned between two flat plates or flanges. Over a period of time, the effectiveness of the sealing member may diminish Additionally, a sealing force of the sealing member may also decrease, thereby leading to leakage between the two mating flanges in case of a surrounding fluid environment. A number of factors may affect a rate at which the sealing force of the sealing member reduces. For example, the type of elastomeric material of the sealing member, wear of the sealing member, environment of use of the sealing member, temperature of the environment, and so on. In addition, exposing the O-ring to an aging fluid, such as air, water, gasoline, brake fluid, or engine coolant may also affect the sealing force of the sealing member.

Various testing procedures are available for testing the predicted life of the sealing members. Such tests may include testing the sealing members in an aging fluid bath serving as a static environment. Further, the test may involve loading of the sealing member in order to develop induced stresses similar to that in a realistic environment. The test may additionally involve testing the sealing member in the aging fluid maintained at a given temperature. However, in practical applications, the temperature of the surrounding fluid may be different than the temperature surrounding the sealing member. Accordingly, the testing procedures may provide erroneous evaluation of the sealing members.

U.S. Pat. No. 5,877,428, hereinafter referred to as the '428 patent, relates to an apparatus for measuring elastomeric properties of a specimen kept under load during a test procedure. The '428 patent describes a method for measuring elastomeric properties of a specimen during the test procedure. However, the test procedure does not describe evaluating a performance of the sealing member in dynamic environmental conditions.

### SUMMARY OF THE DISCLOSURE

In one aspect of the present disclosure, a method for testing a performance of a plurality of sealing members is provided. The method includes providing a testing fixture including at least two blocks. Each of the at least two blocks is in a contacting relationship with a plurality of fixtures. Each of the plurality of fixtures define a groove portion therein. The groove portion is configured to receive one of the plurality of sealing members therein. The method further includes connecting each of the plurality of fixtures with a fluid manifold. The method also includes controlling a temperature of each of the at least two blocks using a thermal device. A temperature associated with the groove portion of each of the plurality of fixtures is based on the temperature of the corresponding block, such that each of the at least two blocks are at temperatures different from each other. The method also includes passing a fluid through each of the plurality of fixtures. The fluid is configured to flow through a channel provided adjacent to and surrounding the groove portion on each of the plurality of fixtures. The method further includes monitoring a response of each of the plurality of sealing members to determine at least one performance parameter of each of the plurality of sealing members based, at least in part, on the controlling of the temperature and the passing of the fluid.

Other features and aspects of this disclosure will be apparent from the following description and the accompanying drawings.

### BRIEF DESCRIPTION OF THE DRAWINGS

FIG. 1 is a perspective view of an exemplary test environment having a test apparatus, according to one embodiment of the present disclosure;

FIG. 2 is a schematic view of a hydraulic circuit of an exemplary test setup including the test apparatus, according to one embodiment of the present disclosure;

FIG. 3 is a perspective view of a testing fixture of the test apparatus, according to one embodiment of the present disclosure;

FIG. 4 is an exploded view of a compressive stress relaxation (CSR) fixture associated with the testing fixture of FIG. 3, according to one embodiment of the present disclosure;

FIG. 5 is a perspective top partial breakaway view of a portion of the testing fixture of FIG. 3, according to one embodiment of the present disclosure;

FIG. 6 is a perspective bottom view of the testing fixture of FIG. 3, according to one embodiment of the present disclosure; and

FIG. 7 is a flowchart of a method for testing a performance of a plurality of sealing members using the test apparatus.

### DETAILED DESCRIPTION

Reference will now be made in detail to specific aspects or features, examples of which are illustrated in the accompanying drawings. Wherever possible, corresponding or similar reference numbers will be used throughout the drawings to refer to the same or corresponding parts.

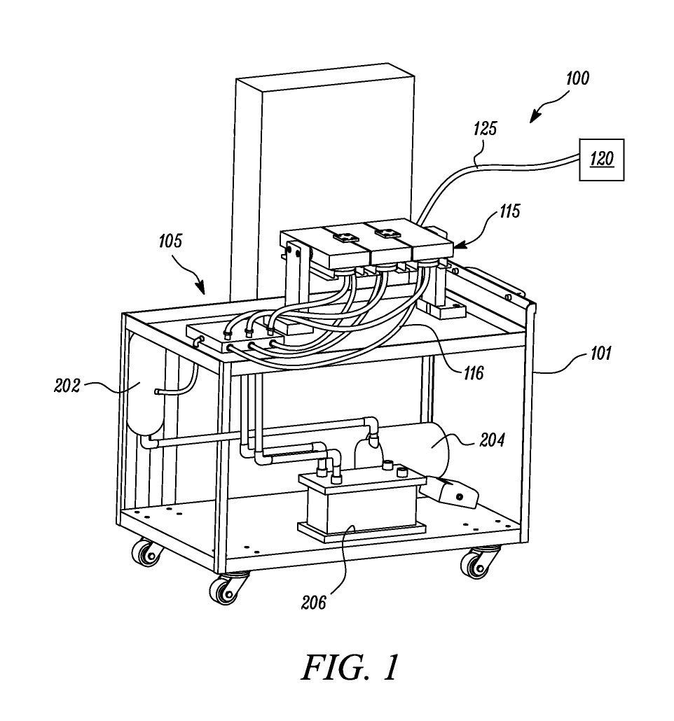

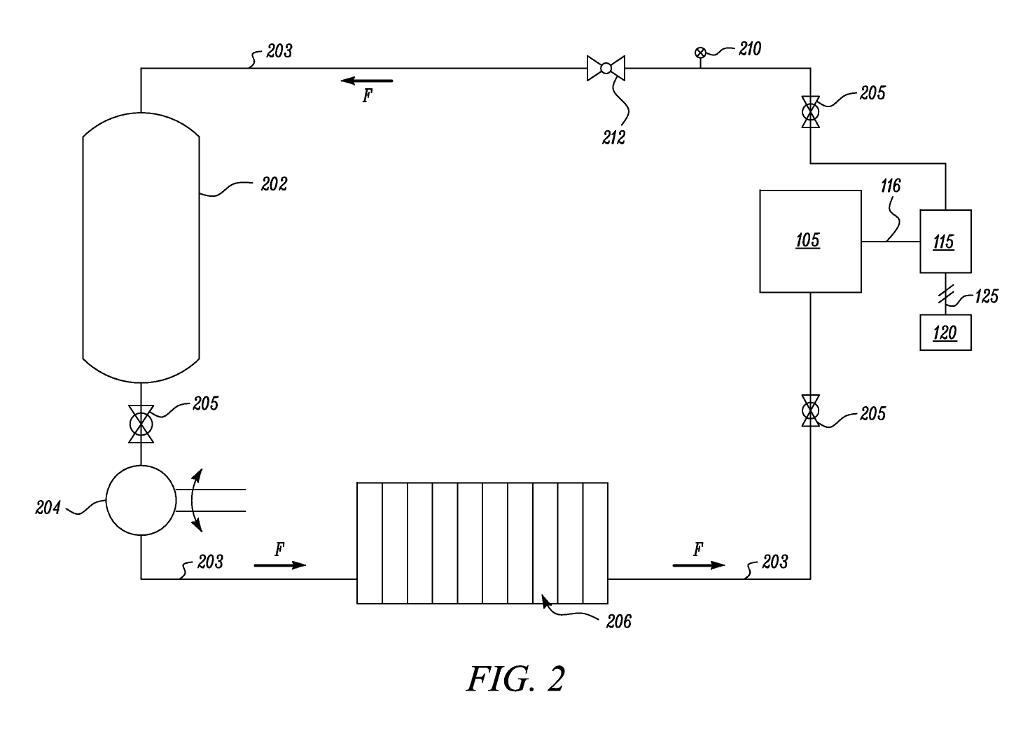

FIG. 1 illustrates an exemplary test apparatus 100, according to one embodiment of the present disclosure. The test apparatus 100 includes a test bench 101, a fluid manifold 105 placed on the test bench 101. FIG. 2 is an exemplary hydraulic circuit associated with the test apparatus 100. Referring to FIGS. 1 and 2, the fluid manifold 105 is configured to transfer a volume of an aging fluid, such as a coolant. Alternatively, the fluid may include a fuel, oil, an emulsion, and the like depending upon a test to be conducted by the test apparatus 100. The fluid manifold 105 is in communication with a testing fixture 115. In an embodiment, the fluid manifold 105 is coupled to the testing fixture 115 via a number of hoses 116 associated therewith.

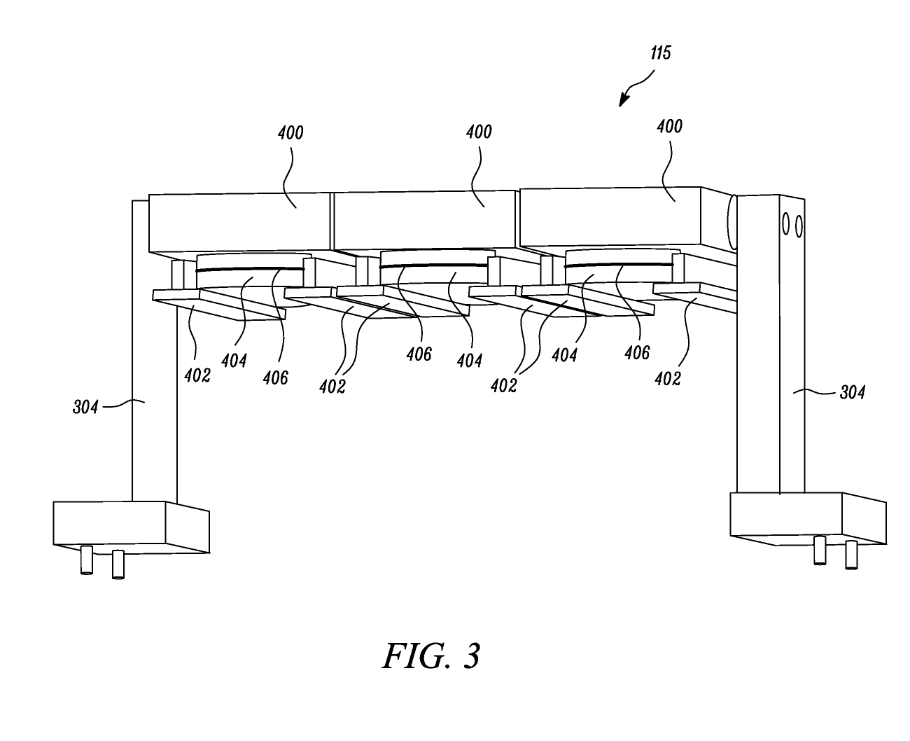

The testing fixture 115 is configured to receive the fluid from the fluid manifold 105 through the hoses 116. The testing fixture 115 is configured to receive a number of sealing members 406 (see FIG. 3) for testing a performance of the sealing members 406. The sealing members 406 may include O-rings or any other sealing members made of a suitable sealing material. The sealing material may be an elastomeric material such as, rubber, used for creating a seal between mating components. The detailed structure and working of the testing fixture 115 will be explained later in connection with FIGS. 3 to 6. The testing fixture 115 is electrically coupled to a control unit 120 via an electrical line 125. The electrical line 125 is preferably made of materials which can withstand various environmental testing conditions, such as presence of relatively high or low temperatures and chemical aging fluids.

As shown in FIGS. 1 and 2, the test apparatus 100 includes a container 202 configured to receive, store, and supply the fluid. The container 202 is hydraulically coupled to different components of the test apparatus 100 through a hydraulic line 203 (see FIG. 2). As shown in FIG. 2, a pump 204 is coupled to the container 202. The pump 204 may be a bi-directional hydraulic motorized pump configured for receiving the fluid from the container 202, and further passing the fluid through other components in the hydraulic circuit under pressure. The flow of the fluid is represented using arrows “F”.

A heat exchanger 206 receives the fluid from the pump 204. The heat exchanger 206 maintains a suitable temperature of the fluid flowing through downstream of the heat exchanger 206. In an example, temperature of the fluid is maintained at approximately 90° C. Alternatively, the temperature of the fluid may depend upon the test to be conducted by the test apparatus 100. The fluid, at a certain temperature and pressure, is fed to the test apparatus 100.

As mentioned earlier, the fluid manifold 105 receives the fluid from the heat exchanger 206. The fluid is further provided to the testing fixture 115 via the hoses 116. The fluid is then discharged from the testing fixture 115 and sent back to the container 202. Additionally or optionally, the hydraulic circuit further includes other components, such as, for example, a multiple flow isolation valves 205 installed at different points to perform flow isolation operation. The hydraulic circuit may also include a pressure gauge 210 and a pressure control valve 212 respectively for monitoring and controlling pressure of the fluid flowing through the hydraulic circuit. The hydraulic circuit may include other components not described herein. The hydraulic circuit explained herein is exemplary.

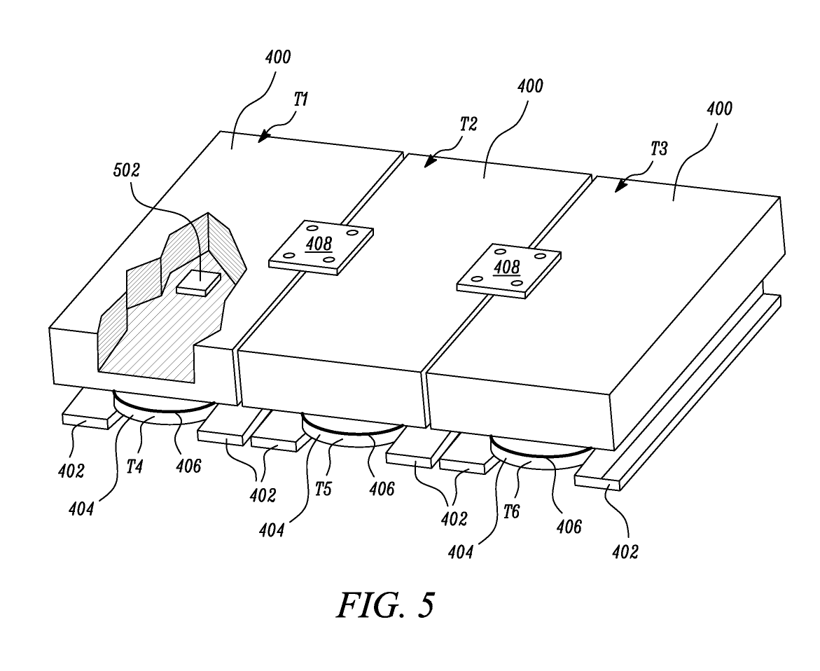

The structure and working of the testing fixture 115 will now be described in detail. As shown in FIG. 3, the testing fixture 115 is coupled to support members 304 for resting the testing fixture 115 on the test bench 101 (see FIG. 1). The testing fixture 115 further includes two or more metal blocks 400. As illustrated, in an example, the testing fixture 115 includes three metal blocks 400. The metal blocks 400 may be made of any suitable metal having substantial thermal conductivity. The metal blocks 400 may be mechanically coupled to each other via connection elements 408 (see FIG. 5). Each metal block 400 includes a thermal device 502 (see FIG. 5), such as, for example, a thermocouple.

The thermal device 502 associated with each of the metal blocks 400 may be operatively connected to the control unit 120. The control unit 120 is configured to independently operate each of the thermal devices 502 associated with the metal blocks 400. Accordingly, each of the metal blocks 400 may be maintained at a predetermined temperature. Legs 402 extend from a bottom surface of each of the metal blocks 400. The legs 402 have a T-shaped rail structure.

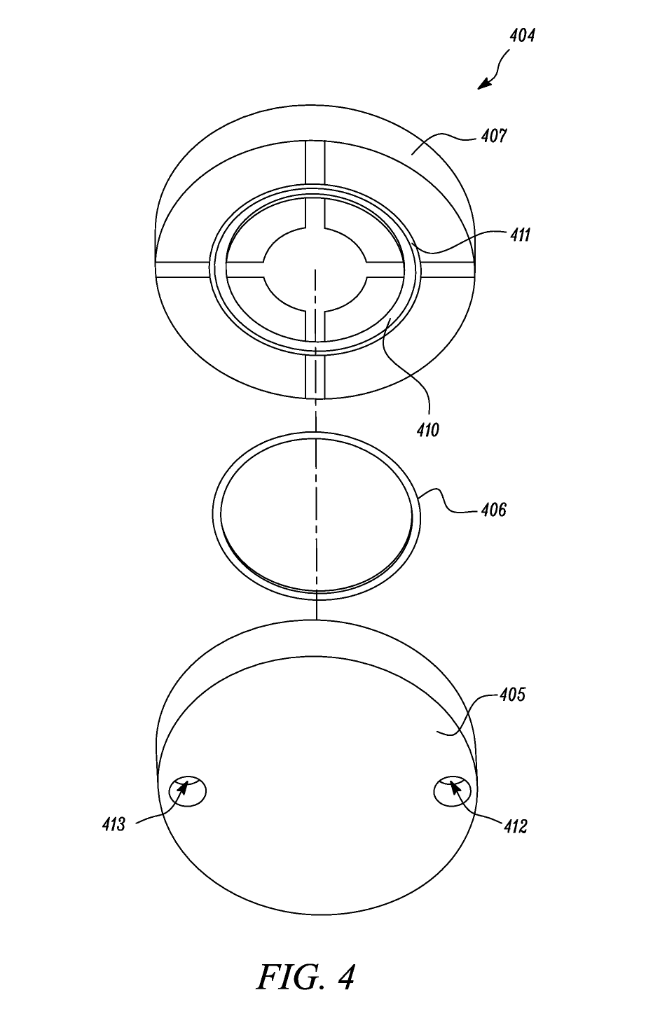

Multiple compressive stress relaxation (CSR) fixtures 404 are coupled between the legs 402 associated with each of the metal blocks 400. FIG. 4 illustrates an exploded view of the CSR fixture 404. The CSR fixture 404 includes a base plate 405, a top plate 407 configured to be secured to the base plate 405. In one embodiment, the base plate 405 is coupled to the top plate 407 via mechanical fasteners (not shown). The CSR fixture 404 has a circular shape, such that a diameter of the CSR fixture 404 may be selected based on dimensions of the sealing member 406 to be tested.

The CSR fixture 404 includes a groove portion 410. The groove portion 410 is centrally disposed on the CSR fixture 404. The groove portion 410 has a ring shaped configuration for receiving the sealing members 406 therein. The CSR fixture 404 includes a channel 411. The channel 411 is positioned adjacent to and surrounding the groove portion 410. More than one channel 411 may be provided on the CSR fixture 404, such that a pair of the channels 411 is included on the CSR fixture 404. The positioning and number of the channels 411 may vary and is not limited to that described herein. Although not visible in the accompanying figures, it should be noted that the groove portion 410 and the channel 411 are provided on corresponding inner surfaces of the top plate 407 and the base plate 405 respectively of the CSR fixture 404, thereby providing a conforming geometry within the CSR fixture 404 for securely holding the sealing member 406 therein and forming a continuous channel for the fluid to flow in a path surrounding the sealing member 406. During testing, the fluid passes through the channel 411 and exchanges heat with the groove portion 410 containing the sealing member 406.

The CSR fixture 404 includes an inlet 412 and an outlet 413 positioned on the base plate 405 of the CSR fixture 404. The inlet 412 is in communication with the hoses 116 for receiving the fluid from the fluid manifold 105. The fluid as received through the inlet 412 is configured to flow through the channel 411, and is further discharged from the outlet 413 of the CSR fixture 404.

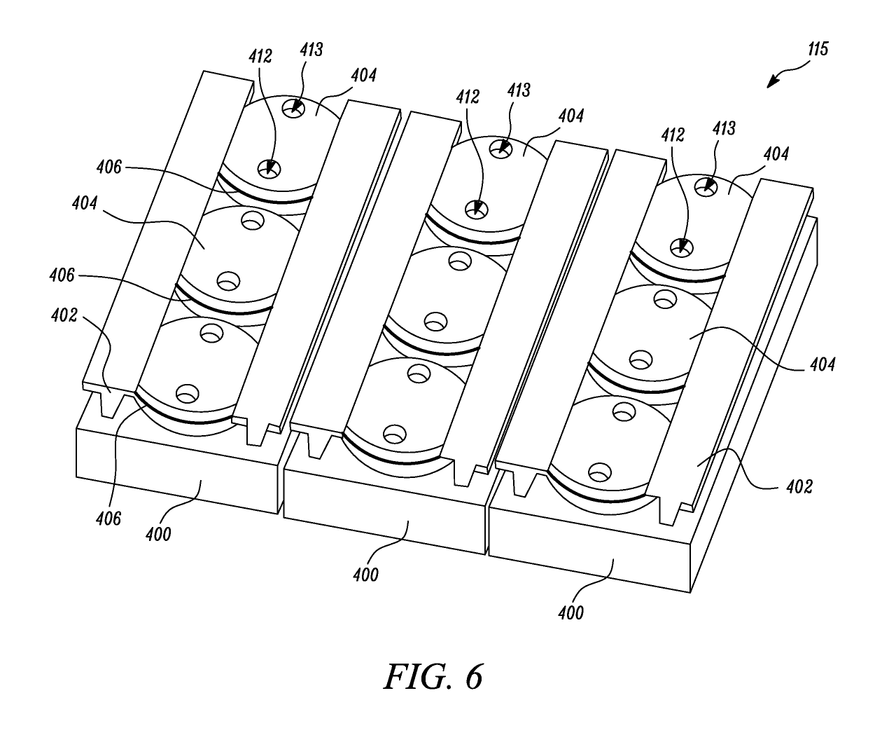

Referring to FIG. 6, three CSR fixtures 404 are positioned between the legs 402 of each of the metal blocks 400. Each of the CSR fixtures 404 has the inlet 412 configured to receive the fluid from the hose 116 and the outlet 413 configured to discharge the fluid from the CSR fixture 404. Each of the CSR fixtures 404 is in a contacting relationship with the respective metal block 400. In one embodiment, nine sealing members 406, that is one sealing member 406 associated with each CSR fixture 404, may be tested simultaneously. The number and dimensions of the CSR fixtures 404 is not limited to that described herein and may vary based on the application. Further, the dimensions of each of the CSR fixtures 404 may be same or different.

The testing of the sealing members 406 will now be described in detail. During testing, the test apparatus 100 is assembled and connected as described above. The control unit 120 operates the thermal devices 502 associated with the metal blocks 400 to independently raise the temperature of each of the metal blocks 400. Heat from the metal blocks 400 is thermally communicated to the CSR fixtures 404, and in turn to the groove portions 410 containing the sealing member 406. Thus, the sealing members 406 are exposed to varying temperatures.

Also, simultaneously, the fluid enters the CSR fixtures 404 through the inlet 412 and circulates through the channel 411 surrounding the sealing member 406. Accordingly, heat transfer may take place with the fluid passing through the channels 411. Referring to FIG. 5, during testing, the metal blocks 400 may be at temperatures T1, T2, and T3 respectively and the temperatures associated with the CSR fixtures 404 may be T4, T5, and T6 respectively. In one example, the temperatures T1 to T6 may vary as follows: T1 may be approximately 300° C., T2 may be approximately 250° C., T3 may be approximately 200° C., T4 may be approximately 175° C., T5 may be approximately 150° C., and T6 may be approximately 125° C.

The testing fixture 115 is configured to test and monitor one or more performance parameters of the sealing material of the sealing members 406 by subjecting each of the sealing members 406 to varying temperatures. The performance parameters associated with the sealing member 406 may include, but not limited to, a life of the sealing member 406, a response of the sealing member 406 to environment temperature variations, affect of temperature variation on sealing force of the sealing members 406, and so on. The control unit 120 may monitor the response of each of the sealing members 406 in order to determine the performance thereof. In one embodiment, the control unit 120 may include a memory or database, and may retrieve corresponding threshold values therefrom. The control unit 120 may compare the response of the each of the sealing members 406 with the threshold and determine the response of the sealing member 406 based on the comparison. In another example, the performance parameters associated with the sealing member 406 may be evaluated after aging of the sealing member 406 in the testing fixture 115 separately from the test apparatus 100.

The control unit 120 may be any known computer processing unit capable of receiving and sending data, signals, instructions etc. to the testing fixture 115 and storing such data in an electronic file for subsequent processing thereof. In an embodiment, the control unit 120 is configured to control, monitor and record operating characteristics associated with the testing fixture 115, and the performance parameters associated with the sealing members 406. The control unit 120 may include an analog interface circuit (not shown) which converts the output signals from the testing fixture 115 into a signal which is suitable for presentation to an input of a microprocessor (not shown) of the control unit 120. The control unit 120 is configured to collect and analyze real time data during a given test procedure during which the testing fixture 115 is exposed to the fluid.

### INDUSTRIAL APPLICABILITY

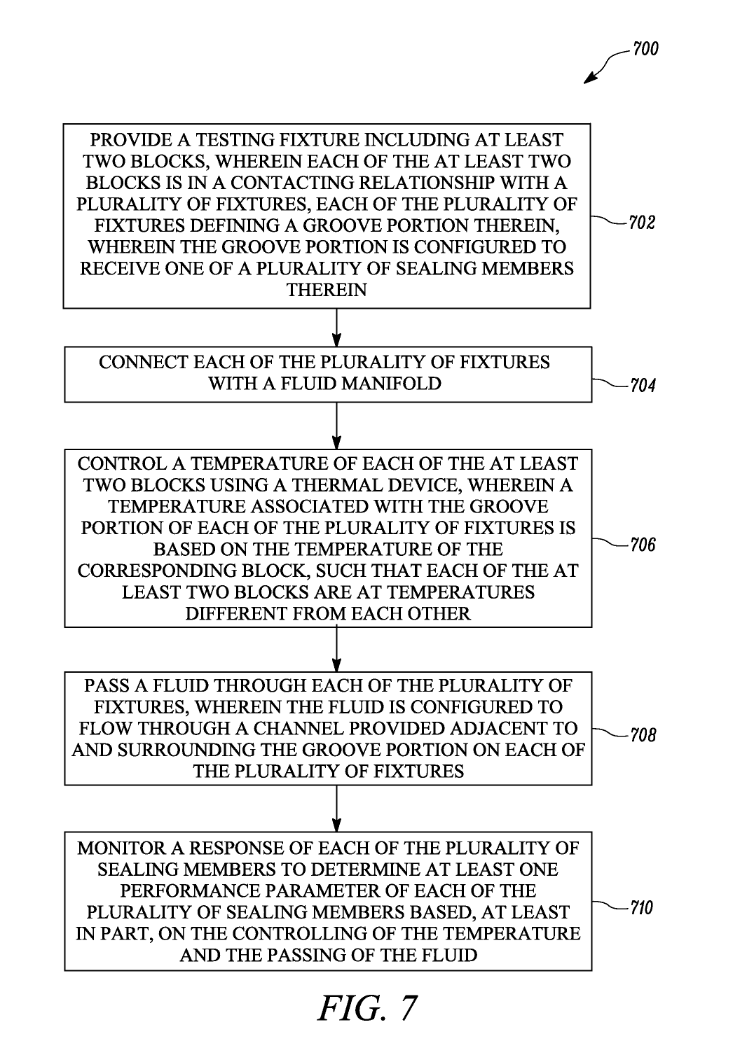

The present disclosure is relates to a system and method 700 for testing the performance parameters of the sealing members 406, industrial applicability of the method 700 described herein with reference to FIG. 7 will be readily appreciated from the foregoing discussion. At step 702, the testing fixture 115 is provided. As described earlier, the testing fixture 115 includes the metal blocks 400 and the CSR fixtures 404. The CSR fixtures 404 have the groove portion 410 configured to receive the sealing members 406.

At step 704, the CSR fixtures 404 are connected with the fluid manifold 105 through the hoses 116. At step 706, the temperature of the metal blocks 400 is controlled by the control unit 120 using the thermal devices 502. Accordingly, the temperature of the groove portion 410 of each of the CSR fixtures 404 is varied based on the temperature of the corresponding metal block 400. The metal blocks 400 may be maintained at different temperatures. At step 708 the fluid is passed through the each of the CSR fixtures 404, such that the fluid enters into the inlet 412 and circulates through the channel 411 and is discharged through the outlet 413. At step 710, the response of each of the sealing members 406 is monitored to determine the performance parameters thereof.

The test apparatus 100, and in turn the testing fixture 115 provides a realistic and dynamic environment for testing of the sealing members 406, such that the temperature associated with the sealing members 406 can be varied independently and at a greater variance compared to the temperature of the fluid. Further, flow of the fluid across the groove portion 410, and in turn the sealing members 406, provides a dynamic and realistic environment similar to the environment that the sealing members 406 may be subject to during actual operation. The control unit 120 monitors the performance parameters associated with the sealing members 406 in real time, thus providing precise and accurate information pertaining to operating characteristics of the sealing members 406 under a dynamic environment. Further in an embodiment, the sealing member 406 as received in the testing fixture 115 may be tested periodically for example, on hourly, daily, weekly, or monthly basis.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for testing a performance of a plurality of sealing members, the method comprising:
providing a testing fixture including at least two blocks, wherein each of the at least two blocks is in a contacting relationship with a plurality of fixtures, each of the plurality of fixtures defining a groove portion therein, wherein the groove portion is configured to receive one of the plurality of sealing members therein;
connecting each of the plurality of fixtures with a fluid manifold;
controlling a temperature of each of the at least two blocks using a thermal device, wherein a temperature associated with the groove portion of each of the plurality of fixtures is based on the temperature of the corresponding block, such that each of the at least two blocks are at temperatures different from each other;
passing a fluid through each of the plurality of fixtures, wherein the fluid is configured to flow through a channel provided adjacent to and surrounding the groove portion on each of the plurality of fixtures; and
monitoring a response of each of the plurality of sealing members to determine at least one performance parameter of each of the plurality of sealing members based, at least in part, on the controlling of the temperature and the passing of the fluid.
